(19) United States
(12) Patent Application Publication
(10) Pub. No.: US 2004/0251443 A1
(43) Pub. Date: Dec. 16, 2004

(54) Gas insulated switchgear for high pressure and medium pressure gas

(76) Inventor: Sen-Yu Wu, Taichung Hsien (TW)

Correspondence Address: DENNISON, SCHULTZ & DOUGHERTY, 612 Crystal Square 4, 1745 Jefferson Davis Highway, Arlington, VA, 22202-3417, US

(21) Appl. No.: 10/461,415

(22) Filed: Jun. 16, 2003

(51) Int. Cl. F16K 25/00

(52) U.S. Cl. 251/172

(57) ABSTRACT

A gas insulated switchgear comprises a switch member, a valve assembly installed in the switch member and a revolving button assembly mounted at an end of the switch member for driving the valve assembly moving. The switch member has a valve chamber, a gas chamber communicated with the a valve chamber and an inlet communicated with the gas chamber, wherein the valve chamber has a tapered shape in a cross-section along an elongated axis and the valve assembly has a shape relative to the valve chamber to be received therein. The valve assembly has a larger end and a smaller end, wherein the larger end faces the gas chamber. Gas is inputted via the inlet and stored in the gas chamber to press the larger end of the valve so that the valve assembly is squeezed in the valve chamber for anti-leakage.

### BACKGROUND OF THE INVENTION

1. Field of the Invention

The present invention relates generally to a switchgear, and more particularly to an improved gas insulated switchgear for high pressure and medium pressure gas.

2. Description of the Related Art

The gas insulated switchgear is developed for decades, there were a lot of inventions that improve the gas insulated switchgear in the prior art. Most of the gas insulated switchgears are improved in the ignition system to get a predetermined function.

Typically, there were gas insulated switchgears respectively applied for low pressure gas, medium pressure gas and high pressure gas. In other words, the gas pressure of the low pressure gas insulated switchgear is lower than the gas pressure of the medium and high pressure gas insulated switchgear, and the gas pressure of the medium pressure gas insulated switchgear is lower than the gas pressure of the high pressure gas insulated switchgear. To prevent from the leakage of gas, designs of the gas insulated switchgears are various according to the gas pressure.

A conventional gas insulated switchgear for low pressure gas has a valve assembly to control gas flow. The valve assembly is tapered in a cross section thereof having a larger end and a smaller end, wherein the larger end is elastically against by a revolving button assembly and has plural of tunnels and the smaller end corresponds with a gas inlet of the switchgear. While the button assembly is started off, the pressure of the gas flowing in via the inlet that force the valve assembly adapted to move toward the button assembly (the valve assembly has an inclined plane for the gas pressure exerted thereon) is substantially equal to the elastic force of the button assembly. Therefore, there is no leakage between the valve assembly and a valve chamber. The button assembly usually has a smaller resistance so that such switchgear can not be applied for medium and high pressure gas. Higher gas pressure makes the valve assembly shifting aside that causes leakage.

The conventional valve assembly is a column and is engaged with plural of O rings in general. Some valve assemblies are co-operated with a controller, such as a ball valve or a control board. The gas insulated switchgear for high pressure has the controller to control the gas flow directly so that there will be no leakage happened.

The gas insulated switchgear for medium or high pressure gas has a more complex structure than the gas insulated switchgear for low pressure gas has so that they has higher cost for manufacture and for assembly.

### SUMMARY OF THE INVENTION

The primary objective of the present invention is to provide a gas insulated switchgear for high pressure gas and medium pressure gas, which has a simpler structure to achieve the anti-leakage function in an accurate action.

The secondary objective of the present invention is to provide a gas insulated switchgear for high pressure gas and medium pressure gas, which is easy for assembly and is free from the drawbacks of the conventional switchgears have.

According to the objectives of the present invention, a gas insulated switchgear comprises a switch member, a valve assembly installed in the switch member and a revolving button assembly mounted at an end of the switch member for driving the valve assembly moving. The switch member has a valve chamber, a gas chamber communicated with the a valve chamber and an inlet communicated with the gas chamber, wherein the valve chamber has a tapered shape in a cross-section along an elongated axis and the valve assembly has a shape relative to the valve chamber to be received therein. The valve assembly has a larger end and a smaller end, wherein the larger end faces the gas chamber. Whereby gas is inputted via the inlet and stored in the gas chamber to press the larger end of the valve so that the valve assembly is squeezed in the valve chamber for anti-leakage.

### BRIEF DESCRIPTION OF THE DRAWINGS

FIG. 1 is a sectional view of a first preferred embodiment of the present invention;

FIG. 2 is a sectional view of a second preferred embodiment of the present invention;

FIG. 3 is a sectional view of a third preferred embodiment of the present invention, and

FIG. 4 is a sectional view of a fourth preferred embodiment of the present invention.

### DETAILED DESCRIPTION OF THE INVENTION

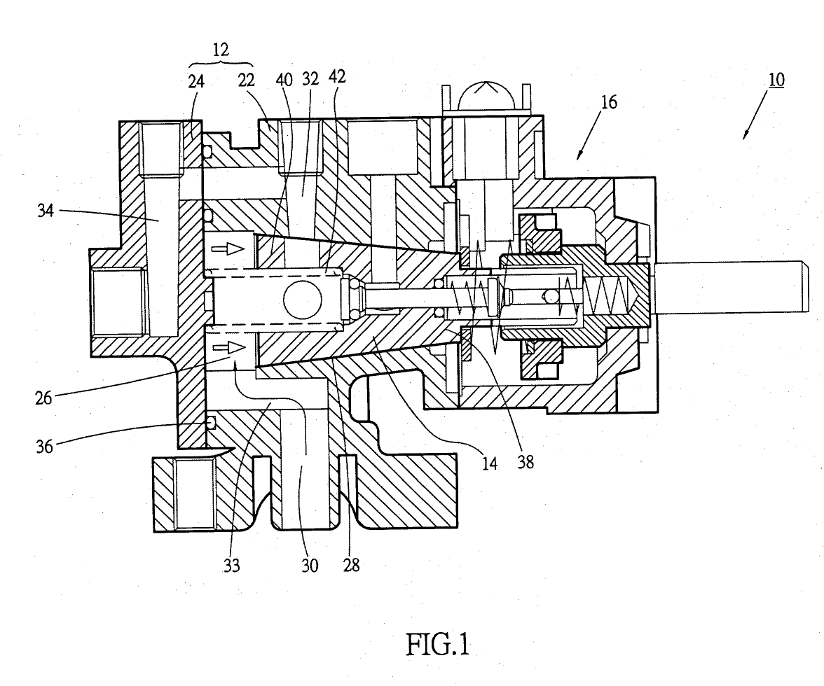

As shown in FIG. 1, a gas insulated switchgear 10 of the first preferred embodiment of the present invention is composed of a switch member 12, a valve assembly 14 and a revolving button assembly 16, wherein the valve assembly 14 and the revolving button assembly 16 are as same as the corresponding elements of a conventional gas insulated switchgear, so they are not described the detail in the flowing description. The main characters of the present invention are:

The switch member 12 has a base member 22 and a cover 24 secured with each other. The base member 22 has a gas chamber 26 and a valve chamber 26 therein and the chambers 26 and 28 are communicated with each other. The valve chamber 26 is a tapered hole in a cross-section along an elongated axis thereof, wherein a larger end of the valve chamber 28 is connected with the gas chamber 26. The base member 12 further has an inlet 30 and a passage 32 in opposite ends thereof and they are respectively communicated with the gas chamber 26 and valve chamber 28. The inlet 30 has a channel 33 communicated with the gas chamber 26. The cover 24 is mounted on the base member 22 at where relative to the gas chamber 26 and the cover 24 has a pad 36 to seal the gas chamber 26. The cover 24 has an outlet 34 communicated with the passage 32. The valve assembly 14 is a tapered element in a cross-section along an elongated axis thereof, wherein a smaller end 38 of the valve assembly 14 is connected with the revolving button assembly 16 and a larger end 40 thereof is corresponding to the gas chamber 26. An elastic member 42 is mounted between the larger end 40 of the valve assembly 14 and the cover 24 to force the valve assembly 14 shifting into the valve chamber 28.

Whereby, medium or high pressure gas is inputted into the inlet 30 and stored in the gas chamber 26. The gas pressure presses the larger end 40 of the valve assembly 14 to make it adapted to shift towards the revolving button assembly 16 so that the valve assembly 14 is squeezed in the valve chamber 28 and higher gas pressure makes the valve assembly 14 squeezed tighter in the valve chamber 28. The gas insulated switchgear 10 of the present invention is under a close condition now. The simple combination of the tapered valve assembly 14 and the tapered valve chamber 28 provides the gas insulated switchgear 10 of the present invention capable of cutting the medium or high pressure gas off in an accurate function.

Beside that, the present invention is easy to be assembled which the cost of manufacture is lower.

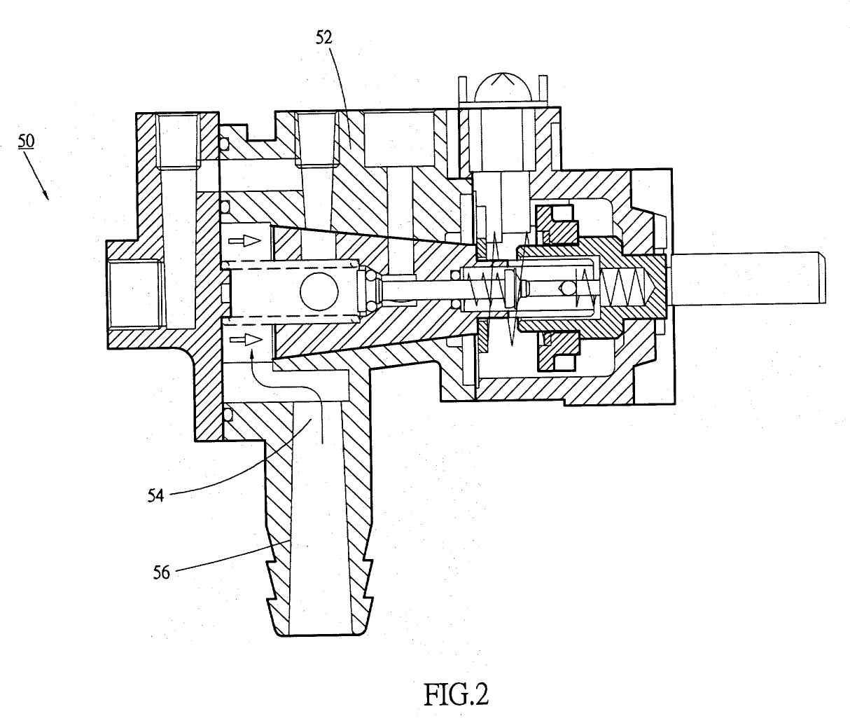

FIG. 2 shows a gas insulated switchgear 50 of the second preferred embodiment of the present invention. The gas insulated switchgear 50 of the second preferred embodiment is similar to the gas insulated switchgear 10 of the first preferred embodiment, except that a base member 52 has an inlet 54 and a tube 56 having an end thereof connected to the inlet 54 and the other end thereof connected to a gas supply (not shown).

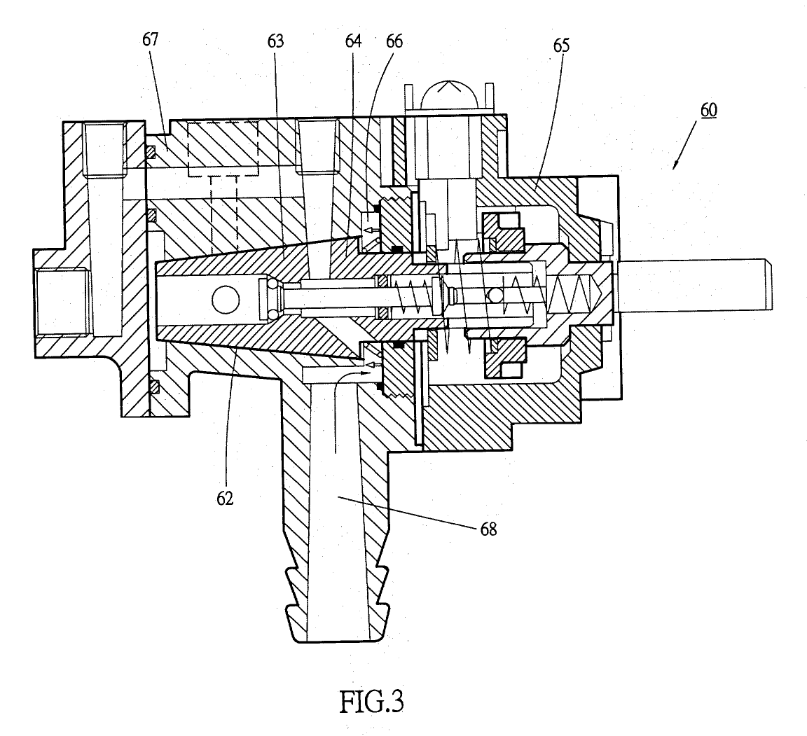

FIG. 3 shows a gas insulated switchgear 60 of the third preferred embodiment of the present invention. The gas insulated switchgear 60 of the third preferred embodiment is similar to the gas insulated switchgear 50 of the second preferred embodiment, except that tapered directions of a valve chamber 62 and a valve assembly 63 are reverse, in other words, a larger end 64 of the valve assembly 63 faces a revolving button assembly 65. A base member 67 has a gas chamber 66 at an end thereof corresponding to the revolving button assembly 65 and communicated with an inlet 68. Whereby, gas is inputted from the inlet 68 and stored in the gas chamber 66 and the gas pressure presses the larger end 64 of the valve assembly 63 to complete the same function as described above.

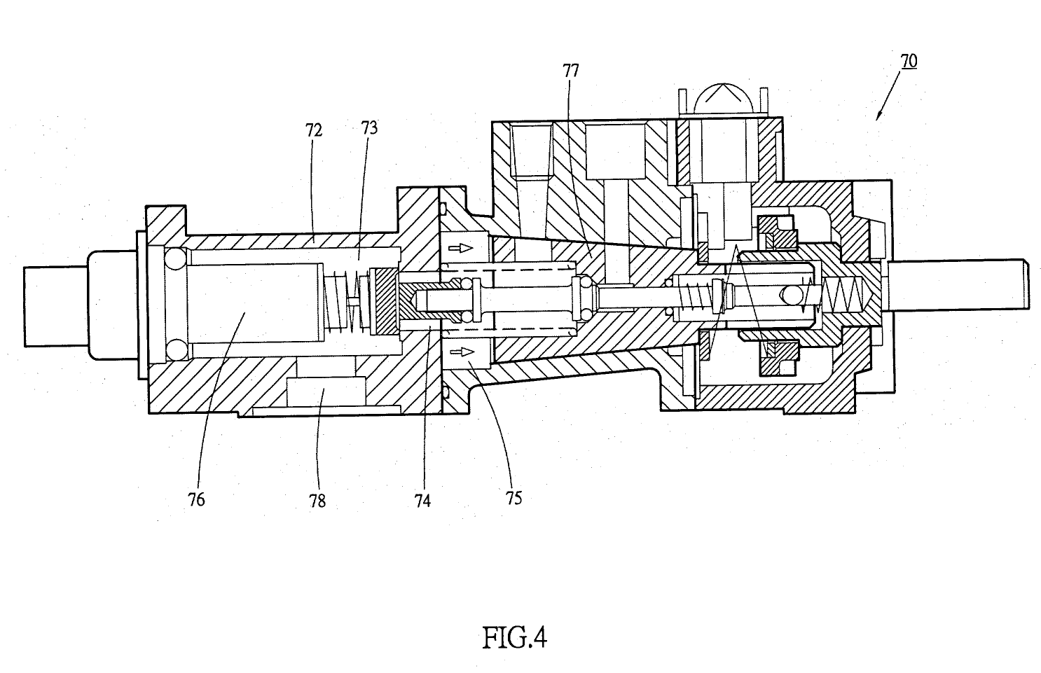

FIG. 4 shows a gas insulated switchgear 70 of the fourth preferred embodiment of the present invention. The gas insulated switchgear 70 of the fourth preferred embodiment is similar to the gas insulated switchgear 10 of the first preferred embodiment, except that a cover 72 has a chamber 73 therein and an hole 74 at an inner end thereof to be communicated with the chamber 73. The chamber 73 is communicated with a gas chamber 75 via the hole 74. An electromagnetic valve 76 that connects to an electric heater (not shown) is received in the chamber 73 and the electromagnetic valve 76 is connected with a valve assembly 77 via the hole 74. The electromagnetic valve 76 is against a sidewall of the chamber 73 to close the hole 74 at initial such that the chamber 73 is isolated from the gas chamber 75. On the contrary, while the electromagnetic valve 76 is activated, the electromagnetic valve 76 leaves the sidewall to make the chamber 73 communicated with the gas chamber 75 via the hole 74 again. The gas insulated switchgear 70 of the fourth preferred embodiment serves the same function as described above.

In conclusion, the gas insulated switchgear of the present invention has a simple structure and is easy to be assembled but it still serves an accurate function of anti-leakage.

What is claimed is:

1. A gas insulated switchgear, comprising a switch member, a valve assembly installed in the switch member and a revolving button assembly mounted at an end of the switch member for driving the valve assembly moving;
the switch member having a valve chamber, a gas chamber communicated with the a valve chamber and an inlet communicated with the gas chamber, wherein the valve chamber has a tapered shape in a cross-section along an elongated axis and the valve assembly has a shape relative to the valve chamber to be received therein;
the valve assembly having a larger end and a smaller end, wherein the larger end faces the gas chamber;
whereby gas is inputted via the inlet and stored in the gas chamber to press the larger end of the valve so that the valve assembly is squeezed in the valve chamber for anti-leakage.

2. The gas insulated switchgear as defined in claim 1, wherein the switch member has a base member and a cover secured with each other, wherein the base member has the gas chamber and the valve chamber respectively at opposite ends thereof.

3. The gas insulated switchgear as defined in claim 2, wherein the cover is secured on the base member at the end having the gas chamber.

4. The gas insulated switchgear as defined in claim 3, wherein the inlet is provided at a side of the base member and is communicated with the gas member.

5. The gas insulated switchgear as defined in claim 2, wherein the gas chamber is provided at a side of the base member corresponding to the revolving button assembly.

6. The gas insulated switchgear as defined in claim 5, wherein the inlet is provided at a side of the base member and is communicated with the gas member.

7. The gas insulated switchgear as defined in claim 6, wherein the base member further has a passage therein communicated with the inlet and the gas chamber.

8. The gas insulated switchgear as defined in claim 2, wherein the switch member further has a pad provided between the base member and the cover.

9. The gas insulated switchgear as defined in claim 3, wherein the cover has a chamber therein, a hole at an inner side thereof for communication the gas chamber with the chamber and an electromagnetic valve received in the chamber and connected to the valve assembly via the hole, wherein the electromagnetic valve is moved between an initial position, in which the electromagnetic valve seals the hole to isolate the chamber from the gas chamber, and an activated position, in which the electromagnetic valve leaves the hole to make the chamber and the gas chamber communicated with each other.

10. The gas insulated switch gear as defined in claim 9, wherein the inlet is provided at the cover and communicated with the chamber.

11. The gas insulated switchgear as defined in claim 2, further comprising an elastic member between the larger end of the valve assembly and the cover to press the valve into the valve chamber.
